(19) United States
(12) Patent Application Publication
(10) Pub. No.: US 2026/0166489 A1
(43) Pub. Date: Jun. 18, 2026

(54) ELECTROCHEMICAL TECHNOLOGY TO PURIFY ELECTROCATALYTIC CO2 AND CO REDUCTION PRODUCT STREAMS FROM SUPPORTING ELECTROLYTES AND OTHER IONIC SPECIES

(71) Applicants: UCHICAGO ARGONNE, LLC, Chicago, IL (US); RENEWCO2 INC., Somerset, NJ (US)

(72) Inventors: YuPo J. LIN, Lemont, IL (US); Karin U. D. CALVINHO, Cranford, NJ (US)

(21) Appl. No.: 19/535,918

(22) Filed: Feb. 10, 2026

Related U.S. Application Data
(63) Continuation of application No. PCT/US2024/043676, filed on Aug. 23, 2024.
(60) Provisional application No. 63/578,315, filed on Aug. 23, 2023.

(51) Int. Cl. B01D 61/44; B01D 61/48; C02F 1/469

(52) U.S. Cl. CPC B01D 61/44; B01D 61/48; B01D 61/485; C02F 1/4695

(57) ABSTRACT

A method for the purification of a reaction crude can include employing one or more electrodeionization modules each including a cathode, an anode, and at least one ion-depletion compartment interposed between pairs of ion-concentration compartments. Each ion-concentration compartment can contain an ion-exchange medium. The method can include passing a reaction crude through each ion depletion compartment. The reaction crude can be produced from a process including at least one ionic species. The method can include supplying current between the anode and the cathode. The method can include recovering an ion-depleted stream from each ion-depletion compartment. The method can include recovering the ionic or ionizable species from each ion-concentration compartment.

### CROSS-REFERENCE TO RELATED APPLICATION

The present application is a continuation of International Application No. PCT/US2024/043676, filed Aug. 23, 2024, which claims priority to U.S. Provisional Patent Application No. 63/578,315 filed on Aug. 23, 2023, the entire disclosure of which is hereby incorporated by reference.

### STATEMENT REGARDING FEDERALLY SPONSORED RESEARCH OR DEVELOPMENT

This invention was made with government support under DE-AC02-06CH11357 awarded by the U.S. Department of Energy. The government has certain rights in the invention.

### FIELD

The presently disclosed technology relates generally to electrochemical technology, and more specifically, in one optional embodiment, to electrochemical technology designed to purify liquid carbon dioxide CO₂ electroreduction crude product streams by removing charged impurities.

### BACKGROUND

The International Energy Agency has reported that the chemicals market contributed 920 million tons in direct CO₂ emissions alone in 2020.

While electrochemical CO₂ reduction research has been prolific for over 30 years, most state-of-the-art processes for the production of value-added products have poor process economics.

A contributing factor to the poor economics is the numerous challenges in product purification. Some of those challenges include the high energy and CO₂ impact associated with heating water from reaction temperatures to the boiling point, evaporation leaves any non-evaporating supporting electrolytes from electrochemical conversion in the residual fraction, high-boiling products such as ethylene glycol and propylene glycol require additional energy input and associated emission to remove the product from the residual fraction, and that the final residual fraction must contain some product which is removed as waste.

### SUMMARY

To address the above-described emissions while generating revenue, the presently disclosed method is demonstrated for the purification and desalting of a MEG crude solution produced through electrochemical reduction of CO₂. The key to achieve this is to obtain a high-purity product from a reaction crude. Additionally, for the application in carbon capture and utilization the reaction crude frequently contains considerably amounts of inorganic C1 carbons e.g. carbonic acid, bicarbonate salts and/or carbonate salts. This, however, should not be taken as a limitation of the technology, as the purification/desalting can be widely applied to CO₂ reduction to liquid product processes. MEG is of significant commercial interest as a key ingredient of polyester fibers and polyethylene terephthalate (PET) resin, applications that consume 80% of its global production capacity.

Another contributing factor to poor economics of most CO₂ reduction processes is low efficiency of the catalyst. Recent advances in catalyst development have allowed for the efficient production of products from CO₂. These enabling technologies has increased the opportunities for processes for current commodity chemicals from CO₂. An example of these enabling catalyst technologies is the recently discovered catalysts based on abundant metals to achieve more than 90% energy efficiency for the reduction of CO₂ to multi-carbon products (e.g., monoethylene glycol (MEG), methylglyoxal, and furandiol). See Calvinho, K. U. D. et al. Selective CO₂ reduction to C₃ and C₄ oxyhydrocarbons on nickel phosphides at overpotentials as low as 10 mV. Energy & Environmental Science 11, 2550-2559 (2018), Calvinho, K. U. D. et al. Surface Hydrides on Fe2P Electrocatalyst Reduce CO₂ at Low Overpotential: Steering Selectivity to Ethylene Glycol. J Am Chem Soc 143, 21275-21285 (2021), and U.S. Patent Application Publication No. 2020/0347502 (Dismukes), each of which is hereby incorporated by reference. This prior innovation translates to lower electricity consumption, and the process is projected to be potentially cost-competitive in the current energy market if sufficiently effective purification technologies are available. The above described electrocatalytic carbon utilization technology is one example of a platform process that can selectively produce a range of single products (e.g., only minor impurities) selected for a change in catalyst and reactions conditions. The technology described herein addresses the low cost and energy efficient purification of products from CO₂ reduction processes such as the ones described above, a skilled artisan will know that other related energy efficient CO₂ reduction processes could also be applied as the feed to this invention.

As an example, based on the above electrocatalytic carbon utilization technology-MEG process is carbon negative, with a net −1.1 MtonCO₂e/ton MEG, considering emissions associated with the electricity used to capture and convert the CO₂. Implementing the electrocatalytic carbon utilization technology-MEG process with 100% market penetration would result in up to 285 Mton of CO₂e emissions reduction potential by 2050, accounting for both the net CO₂ utilized and the emissions avoided giving an environmental positive impact as well as a market advantage. The current green MEG production in the prior art relies on bio-ethanol conversion and only reduces the CO₂ emissions by 25% from the legacy process based on life-cycle analyses from cradle-to-gate.

A key barrier to produce industrial scale and polymer grade of CO₂-to-products by electrocatalytic carbon utilization technology is the development of effective product separation from the raw effluent of the CO₂ reduction process. The raw effluent, as way of an example crude MEG, consists of an aqueous mixture of supporting electrolytes such as potassium bicarbonate (KHCO₃), ionic co-catalysts, and less than 10% impurities of organic acids beside MEG. To obtain the polymer-grade product, the MEG concentration needs to be 99.9%, with less than 20 ppm of organic acids, a maximum of 0.003% ash, and 0.05% water. The state-of-the-art technology utilized in the petrochemical industry for MEG purification (flash evaporation followed by distillation) would not be able to separate the product of interest from the supporting electrolyte. Additionally, the cost of catholyte regeneration is currently calculated to be 63% of the final product cost in the electrosynthesis of multi-carbon products. See Sisler, J. et al. Ethylene Electrosynthesis: A Comparative Techno-economic Analysis of Alkaline vs Membrane Electrode Assembly vs CO₂—CO—C₂H₄Tandems. ACS Energy Letters 6, 997-1002 (2021), which is incorporated by reference.

To address the challenges in economical product purification, one embodiment of the presently disclosed technology includes adding electrochemical separation technology, e.g., electrodeionization (EDI) (e.g., see FIG. 2), resin-wafer electrodeionization (RW-EDI, e.g., see FIG. 3), and/or reverse-osmosis, onto existing production of liquid commodity chemical crude solutions (such as, but not limited to, alcohols, glycols, aldehydes, ketones, carbohydrates, and/or carboxylic acids) from upstream CO₂ electroreduction.

The following patent and published application are relevant to the presently disclosed technology: U.S. Pat. No. 10,676,833 and WO 2021/236746, which are hereby incorporated by reference.

In one embodiment, the presently disclosed technology is directed to a method for the purification of a reaction crude can include employing one or more electrodeionization modules each including a cathode, an anode, and at least one ion-depletion compartment interposed between pairs of ion-concentration compartments. Each ion-concentration compartment can contain an ion-exchange medium. The method can include passing a reaction crude through each ion depletion compartment. The reaction crude can be produced from a process including at least one ionic species. The method can include supplying current between the anode and the cathode. The method can include recovering an ion-depleted stream from each ion-depletion compartment. The method can include recovering the ionic or ionizable species from each ion-concentration compartment.

### BRIEF DESCRIPTION OF THE DRAWINGS

The foregoing summary, as well as the following detailed description of the presently disclosed technology, will be better understood when read in conjunction with the appended drawings, wherein like numerals designate like elements throughout. For the purpose of illustrating the presently disclosed technology, there are shown in the drawing's various illustrative embodiments. It should be understood, however, that the presently disclosed technology is not limited to the precise arrangements and instrumentalities shown. In the drawings:

FIG. 1 is a schematic diagram of one processing system of the prior art;

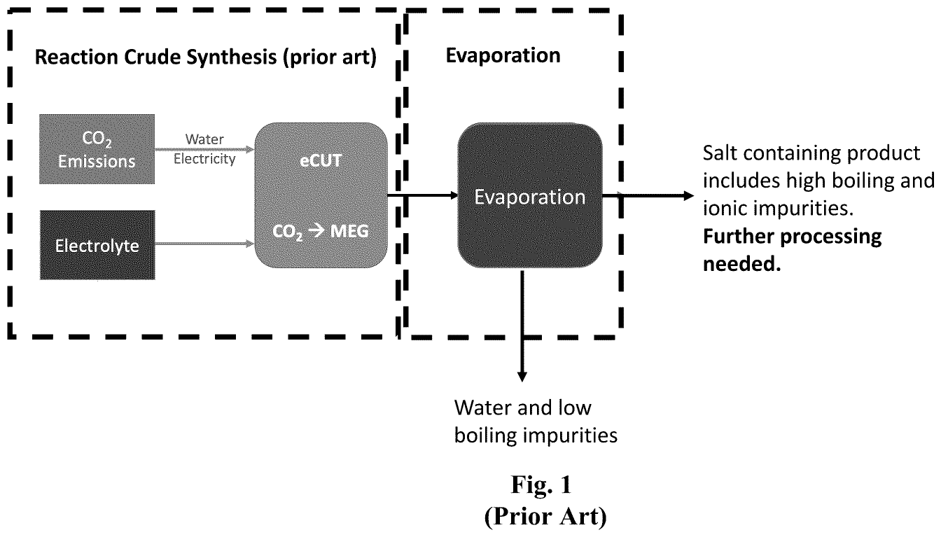

FIG. 2 is a schematic diagram of a conventional electrodeionization (EDI) unit;

FIG. 3 is a schematic diagram of a conventional resin-wafer electrodeionization (RW-EDI) unit;

FIG. 4 is a schematic diagram of one embodiment of the presently disclosed technology, where an electrochemical separation system is shown to the left, its separation mechanism is shown in the center, and a capture acid titer is shown to the right;

FIG. 5a is a graph charting formic acids concentration profile in feed and capture tanks according to one embodiment of the presently disclosed technology;

FIG. 5b is a graph charging energy consumptions and estimated operating costs to remove formic acids from crude e-MEG according to one embodiment of the presently disclosed technology;

FIG. 6 is a schematic diagram of one embodiment of the presently disclosed technology;

FIG. 7 is a schematic diagram of another embodiment of the presently disclosed technology;

FIG. 8 is a schematic diagram of one embodiment of the presently disclosed technology;

FIG. 9a is a schematic diagram of one embodiment of the presently disclosed system shown an RW-EDI system used for purifying crudes with low or no carbonic acid, bicarbonate and/or carbonate salts or derivatives thereof showing the membrane configuration and bipolar membrane adjacent to the anode and cathode constituting the electrode rinse compartments;

FIG. 9b is a schematic diagram of one embodiment of presently disclosed system showing the membrane configuration and showing the modification for the purification of carbonic acid, bicarbonate, and/or carbonate salts or mixtures thereof replacing the bipolar membrane at the electrode rinse compartments;

FIG. 10a is another example of the process crude purification as a function of time according to one embodiment of the presently disclosed technology, wherein the increase in mono-ethylene glycol concentration shows that product is being concentrated upon purification and drop in formic acid concentration shows the degree of removal of this ionic species as a function of time on stream in the Resin Wafer (RW) Electrodeionization (EDI) (RW-EDI) unit; and

FIG. 10b is another example of the process crude purification as a function of time according to one embodiment of the presently disclosed technology, wherein the drop in conductivity shows the degree of removal of all ionic species as a function of time on stream in the Resin Wafer (RW) Electrodeionization (EDI) (RW-EDI) unit.

### DETAILED DESCRIPTION

While systems, devices and methods are described herein by way of examples and embodiments, those skilled in the art recognize that the presently disclosed technology is not limited to the embodiments or drawings described. Rather, the presently disclosed technology covers all modifications, equivalents and alternatives falling within the spirit and scope of the appended claims. Features of any one embodiment disclosed herein can be omitted or incorporated into another embodiment.

Any headings used herein are for organizational purposes only and are not meant to limit the scope of the description or the claims. As used herein, the word “may” is used in a permissive sense (i.e., meaning having the potential to) rather than the mandatory sense (i.e., meaning must). Unless specifically set forth herein, the terms “a,” “an” and “the” are not limited to one element but instead should be read as meaning “at least one.” The term “ionic” is defined herein to cover either or both of ionic, species such as acid, bases, and salts, and/or ionizable species that become charged under the process conditions. “Ionic” should therefore be read as meaning either or both of the above definitions. The terminology includes the words noted above, derivatives thereof and words of similar import.

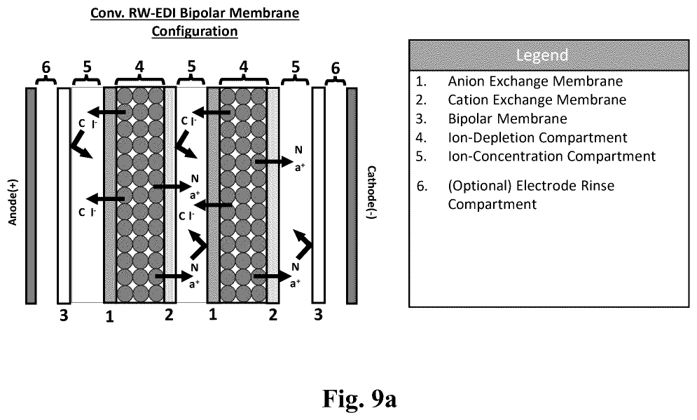

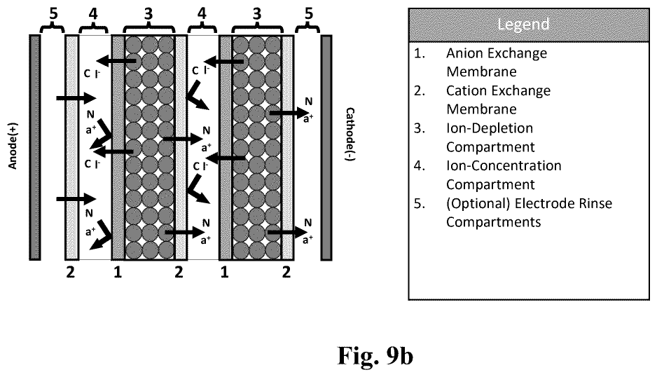

One benefit of EDI to separate organic acid is its extraction and certain degrees of selectivity in a continuous, scalable process. RW-EDI has the benefit of achieving high product purification with lowered energy costs compared to conventional EDI and other processes such as evaporation. Additionally, the process crude from electrochemical or biological processes has a commonality that they are generally of low concentration and higher product purity are required for the economical production of chemicals form carbon utilization technologies. The presently disclosed technology allows for the economic/energy efficient purification of CO₂ reduction products from reaction crudes. Another feature of CO₂ derived reaction crudes is the presence of carbonic acid, bicarbonate and/or carbonate salts and/or derivates thereof, the presence of these ionic species is detrimental to the bipolar membrane in conventional EDI or RW-EDI systems. In one embodiment of the presently disclosed technology, these carbonic acid derived ionic species are removed through a modification of the EDI cell that replaces the bipolar membrane as described in FIG. 9b.

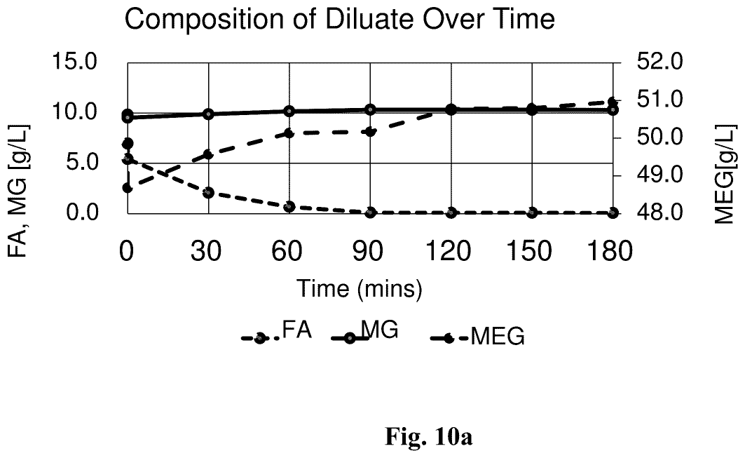

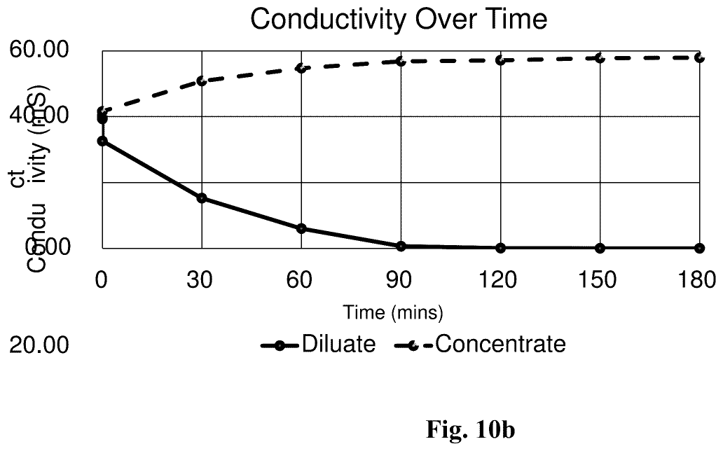

FIGS. 10a and 10b show examples of the purification of formic acid (FA) from a reaction crude mixture consisting of mono-ethylene glycol and methylglyoxal. FIG. 10a shows the ionic species exemplified by formic acid being removed through the drop in concentration, this reaction progress is also seen in FIG. 10b as a reduction in solution conductivity in the ion depletion chamber and a corresponding increase in conductivity in the ion-concentration chamber showing the ion migration. FIG. 10a additionally shows the non-ionic species remaining in the ion-depletion compartment eluent purifying these products.

In one optional embodiment, the process integration of the presently disclosed technology is designed to and/or will be able to produce commodity chemical solutions or mixtures thereof from CO₂ feedstock by 1) removing the supporting electrolyte, ionic co-catalysts, dissociated organic acids, organic salts, and other ionic species; and 2) capturing the output stream with reduced ionic content for downstream processing.

In another optional embodiment, the process integration of the presently disclosed technology is designed to and/or will be able to produce commodity chemical solutions or mixtures thereof from CO₂ feedstock by 1) removing non-ionic by-products, co-catalysts from an ionic species; and 2) capturing the output ionic species product stream with reduced non-ionic content for downstream processing.

Referring to FIG. 9b, in one optional embodiment of the presently disclosed technology the ionic species is/are carbonic acid, bicarbonate salt and/or carbonate salts and/or a combinations and/or derivatives of these the ionic concentrate compartment adjacent to the cathode and anode electrode the conventionally use bi-polar membrane (FIG. 9a is replaced with an CEM and AEM ion-concentrate CEM cell at the cathode and anode respectively (see FIG. 9b). In another embodiment one or both of the former bipolar membranes are replaced with porous separators so-called diaphragms while the other membrane is replaced by a cation or anion-exchange membrane. This avoids the production of gaseous carbon dioxide inside the bipolar membrane which has been shown to otherwise prevent long term stability.

Referring to FIGS. 9a and 9b, in one optional embodiment of the presently disclosed technology an electrode rinse compartment is interposed adjacent to the cathode and anode.

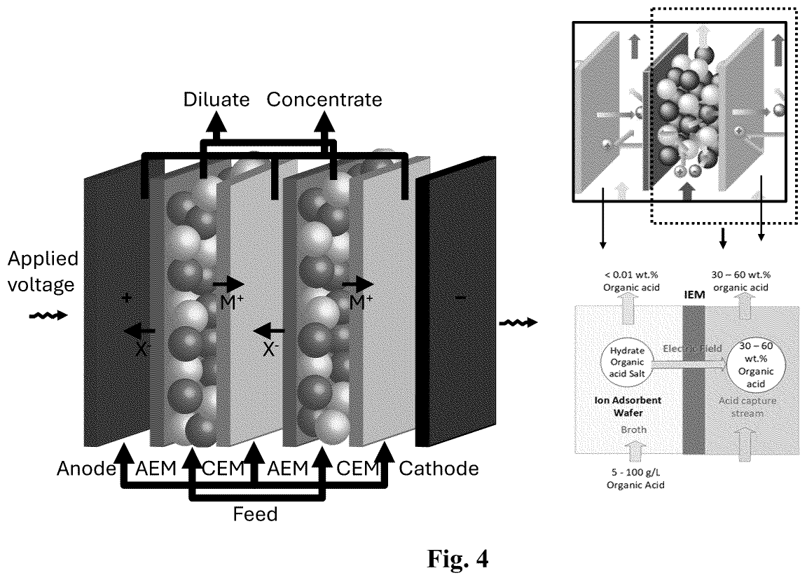

Referring to FIG. 4, in one optional embodiment of the presently disclosed technology, dilute charges in a feed stream are adsorbed and concentrated on the adsorbent, e.g., ion-exchange resin beads or ion-exchange media. With the high concentration of ions on the adsorbent, the ions are electrochemically extracted from the ion-depletion compartment into the capture stream in the ion-concentration compartment by crossing the ion-exchange membrane (IEM). Although, the electrically driven force extracts only the charge species from the feed-stream, because of the water hydration on every ion, water is also transported along with the ions. The final titer of extracted organic acid can be dependent on the operation conditions and hydrophilicity of ion-exchange membrane (IEM), both the cationic and anionic-exchange membrane (CEM and AEM). In a current commercial IEM, for example, the hydration ratios of water to pass the IEM is ranging from 7-20 moles to mole of H₂O per ionic compound. This corresponds to a molar concentration of 4-13 mol %, leading to a capture titer of formic acid which may optionally be in the range of 110-260 g/L using a commercial IEM for the separation. With recent advances in membrane technology a higher product concentration is achievable preferably in the range of 4-40 mol %.

In one embodiment of the presently disclosed technology, the desired product is a non-ionic species, and the target ionic-product concentration is preferably in the range of 10 ppm-4 mol %.

In another embodiment of the presently disclosed technology, the desired product is the ionic species and the target product concentration for a downstream processing is 4-40 mol %. Particularly for these products reducing initial water content is crucial to reduce final product costs and achieve industrial cost metrics.

In another example of the presently disclosed technology, the RW-EDI process can be used to concentrate the produced a small molecule product of C<4, such as formic acid from formic acid production, or other small molecule organic acids such as lactic acid, acetic acid etc. Typical feeds could come from electrochemical CO₂ reduction, biomass conversion, other biological processes where the concentration of product in water solutions is fairly low, 10-100 g/L.

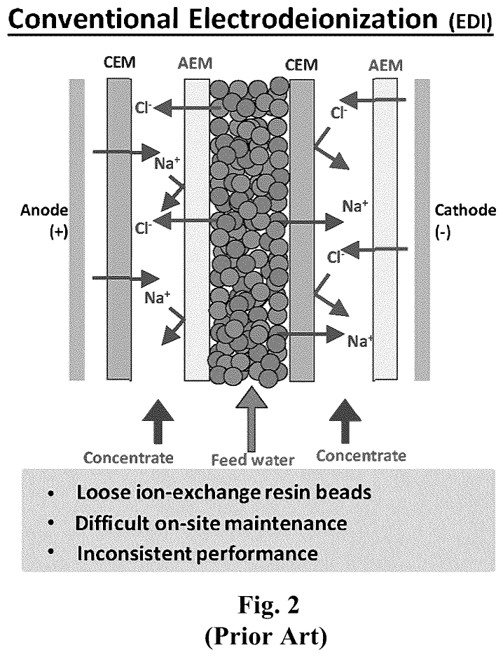

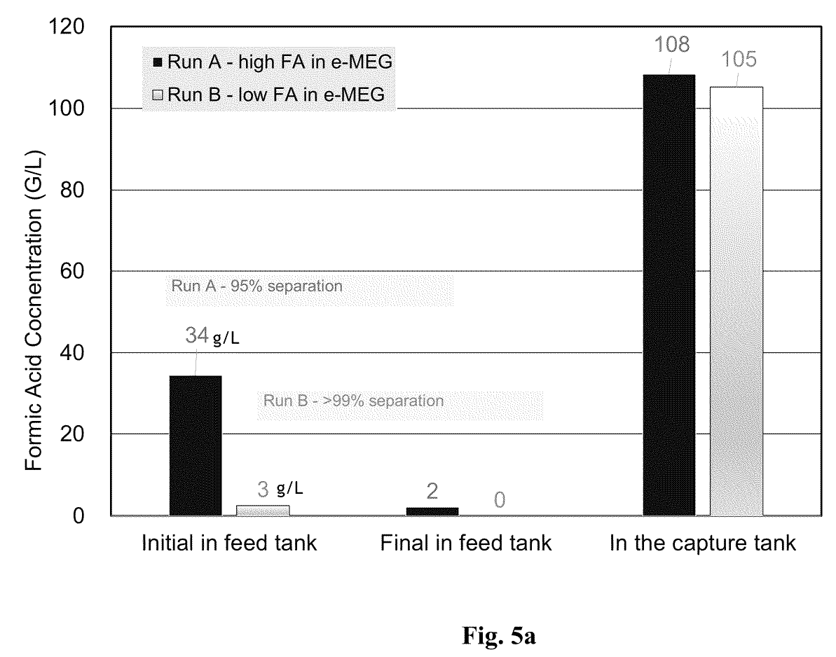

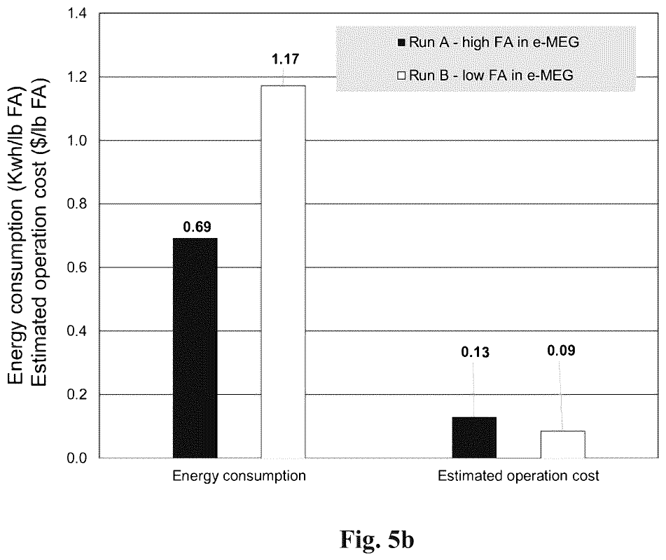

The presently disclosed technology shows that a feature of the RW-EDI process is that the concentrated titer of the captured small organic acids, which are in the range of C1-C8, preferentially in the range of C1-C4, is not influenced by the concentrations in the feed stream. FIG. 5a shows comparison of formic acid separation performance as an example, from a crude mono-ethylene-glycol (MEG) produced from an electrocatalytic reduction of CO₂. In this case, formic acid/formate were impurities along with other inorganic salts and the electrolyte compound. FIG. 2a shows the capture formic acid/formate titers in the capture stream by electrochemical separation device. Regardless of the distinct initial formic acid concentration varying >10-fold, i.e., 2.6 vs. 34 g/L, the captured titer remained constant around 105-108 g/L. This represents 5-40 times concentrated titer in one step.

FIG. 2b shows low energy consumptions and estimated processing costs. The economic impact of the presently disclosed technology is also that the process costs of formic acid capture also showed a low dependence on the initial formic acid concentration even across this 10-fold difference. In contrast, conventional formic acid concentration costs are strongly dependent on feed concentration as the energy input scales with concentration. The estimated operational cost of formic acid recovery from the crude MEG is $0.13 and $0.16/lb of formic acid. This would greatly reduce the operational cost of the final product recovery using conventional heat based concentration methods.

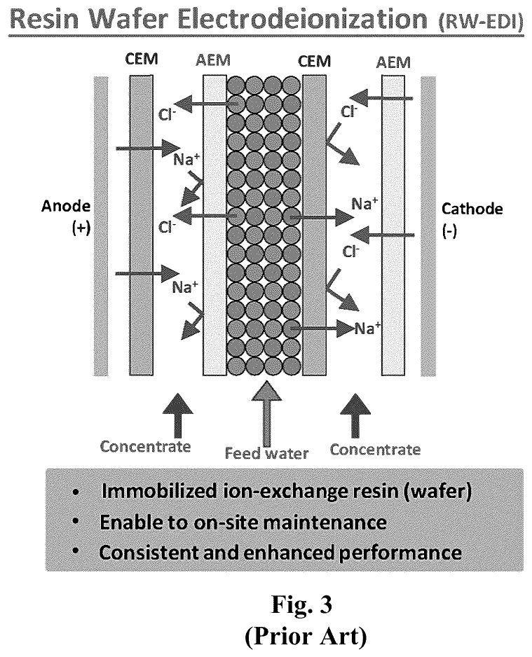

FIG. 2 and FIG. 3 illustrates two configurations of the ion-exchange medium in the ion-depletion compartment which forms the basis for this invention. In one embodiment the ion-exchange medium is randomly distributed in the latter the ion-exchange medium is organized in a resin wafer configuration that allows the efficient purification of the ion-depletion compartment product stream to achieve high-product purity.

In one embodiment the ion-exchange medium consists of ion-exchange beads fused together using a non-ionic binder polymer. This structure imparts a combination of ionic/hydrophilic and non-hydrophilic/hydrophobic regions in the ion exchange resin wafer.

FIG. 4 shows the configuration of two electrodeionoization modules where two pairs of ion concentration compartments are placed with interposed ion-depletion compartment. FIG. 4 show the application of a bias/current between EDI cathode and anode to drive the recovery of the ionic species from an ion-concentration compartment and/or the recovery of a non-ionizable species in the ion depleted compartment/stream.

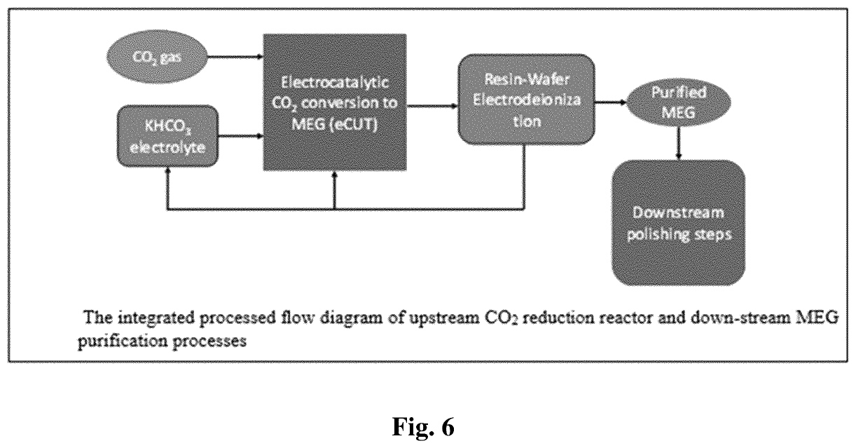

Referring to FIG. 6, one example of a process of the presently disclosed technology includes upstream monoethylene glycol (MEG) production and in-situ RW-EDI MEG purification of ionic species (e.g., electrolyte, ionic catalyst, ionic co-catalyst, and/or organic acids). The presently disclosed technology is not limited to use with MEG production and/or purification, and the presently disclosed technology can be employed with other building blocks for various scientific reactions, such as a variety of glycols including ethylene glycol, diethylene glycol, triethylene glycol, and also furandiol, methylglyoxal, ethanol, and other compounds that are water soluble between 0-100° C. and are uncharged.

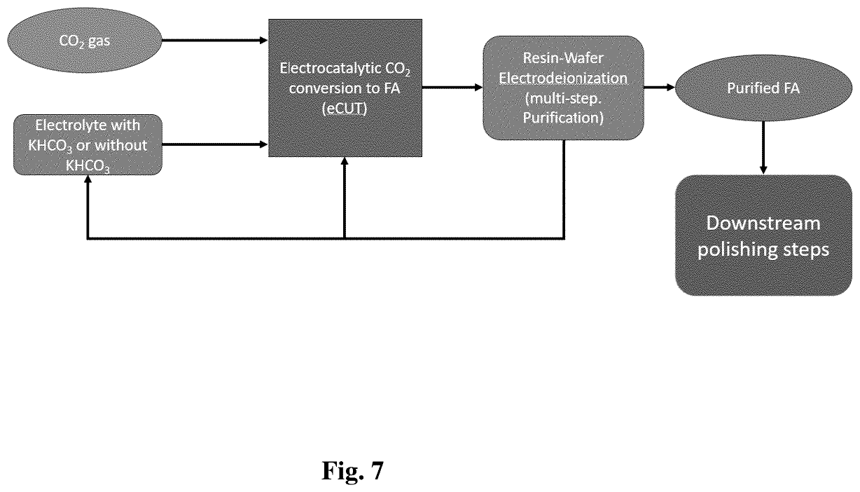

Referring to FIG. 7, one example of a process of the presently disclosed technology includes upstream formic acid/formate (FA) production and in-situ RW-EDI FA purification of the ionic species/product (e.g., FA) from uncharged impurities such as methyl glyoxal, furandiol, ethanol, ethylene glycol. The presently disclosed technology is not limited to use with FA production and/or purification, and the presently disclosed technology can be employed with other chemicals for various scientific reactions, such as a variety of organic acids including formic acid, potassium formate, sodium formate, other alkali earth formates and other compounds that are water soluble between 0-100° C.

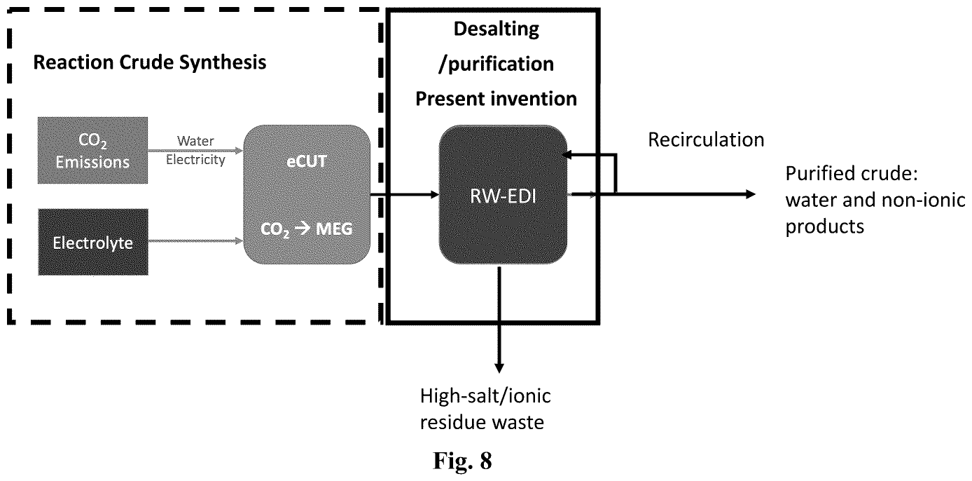

Another example of a process of the presently disclosed technology includes RW-EDI purification of a product stream, such as that shown in FIG. 8.

The purification cost to obtain the desired high-quality product is one of the critical factors in determining commercialization's economic viability. Such a separation cost challenge will very likely occur in all the emerging CO₂ utilization pathway that utilizes a soluble supporting electrolyte to manufacture liquid chemicals. Therefore, success in using RW-EDI to lower purification costs can provide an enabling industrial technology for a cost-competitive sustainable chemical production.

Electrochemical technologies are scalable and modular systems. The proposed process of electrochemical separations added to CO₂ utilization enables a decentralized manufacture process to produce low carbon, sustainable chemicals at any CO₂ point source (or near a CO₂ transport line such as a pipeline or in economical truck or rail transport distance) located near affordable electricity. Therefore, this combined technology will provide a pathway toward the mission of chemical manufacturing decarbonization.

An initial performance measurements of a simulated synthetic crude MEG purification using RW-EDI was conducted successfully. Without optimization of the RW material, the RW-EDI was able to remove >80% of ionic impurities and process cost estimated around $2.0/tonne of crude MEG.

In one embodiment, to be a commercially viable product, the MEG produced from electrocatalytic carbon utilization technology needs to be a polymer grade quality. In the current MEG market, the purity of polymer grade MEG needs to contain less than 10 ppm of ionic impurities particularly organic acids. Another key challenge of commercialization is the cost of electrolyte KHCO₃ used in the electrocatalytic carbon utilization technology process, near 63% of the overall MEG production cost. Therefore, in one embodiment, the presently disclosed technology is aimed to address the issue of low-cost MEG purification. The problem of supporting electrolyte separation is applicable across a wide range of CO₂ reduction technologies that produces liquid products.

MEG is a key ingredient of polyester fibers and polyethylene terephthalate (PET) resin, applications that consume 80% of its global production capacity. The electrocatalytic carbon utilization technology-MEG process is carbon negative, with a net −1.1 MtonCO2e/ton MEG, considering emissions associated with the electricity used to capture and convert the CO₂. Implementing the electrocatalytic carbon utilization technology-MEG process with 100% market penetration would result in up to 285 Mton of CO₂e emissions reduction potential by 2050, both the net CO₂ utilized, and the emissions avoided.

Therefore, in at least one embodiment, the presently disclosed technology provides a pathway to enable the development of decarbonized manufacturing of chemicals by removing the technical and financial risks of commercialization for the industrial sector. In addition, the presently disclosed technology also can be applied into other CO₂ and/or CO utilization technology to produce cost-effective commodity chemicals to replace petroleum-based chemicals in the current market.

The following exemplary embodiments further describe optional aspects of the presently disclosed technology and are part of this Detailed Description. These exemplary embodiments are set forth in a format substantially akin to claims, although they are not technically claims of the present application. The following exemplary embodiments refer to each other in dependent relationships as “embodiments” instead of “claims”.
1.A. A method for economical product purification, the method comprising adding electrochemical separation technology onto existing production of liquid commodity chemical crude solutions from upstream CO₂ or CO electroreduction.
2.A. A method of using resin-wafer electrodeionization (RW-EDI) purification to purify crude from an electrochemical process, particularly for MEG and FA.
3.A. A method for the purification of a reaction crude comprising: a) electrodeionization modules comprising a cathode, anode and at least one ion-depletion compartment interposed adjacently between pairs of ion-concentration compartments, each compartment containing an ion-exchange medium, b) a reaction crude from an electrochemical or biological process comprising at least one ionic or ionizable species that either needs to be removed or recovered, c) passing the reaction crude through said ion depletion compartment, d) supplying current between anode and cathode, e) recovery of the ion-depleted stream from said ion-depletion compartment, f) recovery of the ionic and or ionizable species from said ion-concentration compartment.
3.B. In combination with Embodiment 3.A. where the ion-exchange medium is a resin-wafer consisting of one or more anion and cation exchange beads fused together with a binder polymer to achieve a resin wafer consisting of hydrophobic and hydrophilic domains and with internal-porosity exposing the hydrophilic domains.
3.C. In combination with Embodiment 3.A. or 3.B. in which the ionic species is a small molecule acid with fewer than 4 carbon atoms, exemplified by formic acid, acetic acid, lactic acid, butanoic acid, or derivatives, or salts thereof and/or ionic species comprises inorganic acids exemplified as carbonic acid, bicarbonate, carbonate or salts thereof or mixtures of one or more of the former.
3.D. In combination with any one of Embodiment 3.A.-3.C. where the reaction crude contains a small ionic species or ionizable species of varying concentration and the desired product stream recovered from the ion-concentration compartment is desired to be in a constant concentration range. Preferentially, in which the ionic concentration of the product is desired in the range of 10 ppm to 13 mol % in water.
3.E. In combination with any one of Embodiment 3.A.-3.D. where the reaction crude contains monoethylene, diethylene glycol, triethylene glycol, propylene glycol, or mixtures thereof or other water soluble non-charged product molecules produced from the reduction of carbon dioxide or carbon monoxide.
3.F. In combination with any one of Embodiment 3.A.-3.E. where the use of resin-wafer/RW-EDI reduces the energy consumption compared to conventional evaporation techniques.
3.G. In combination with any one of Embodiment 3.A.-3.F. where the reaction crude contains formic acid and/or alkali or alkali-earth metal salt (collectively formate salts) or combinations thereof and the formic acid or formate salt is the desired product. In which the ion-concentration of the product is desired in the range of 0.1-50 wt % in water.

While the presently disclosed technology has been described in detail and with reference to specific examples of CO₂-based chemicals that can be purified with it, it will be apparent to one skilled in the art that various changes and modifications can be made therein without departing from the spirit and scope thereof. It is understood, therefore, that the presently disclosed technology is not limited to the particular embodiments disclosed, but it is intended to cover modifications within the spirit and scope of the presently disclosed technology as defined by the appended claims.

What is claimed is:

1. A method for the purification of a reaction crude, the method comprising:
employing one or more electrodeionization modules each comprising a cathode, an anode, and at least one ion-depletion compartment interposed between pairs of ion-concentration compartments, each ion-concentration compartment containing an ion-exchange medium;
passing a reaction crude through each ion depletion compartment, the reaction crude being produced from a process comprising at least one ionic species;
supplying current between the anode and the cathode;
recovering an ion-depleted stream from each ion-depletion compartment; and
recovering the ionic or ionizable species from each ion-concentration compartment.

2. The method of claim 1, wherein the ion-exchange medium is a resin-wafer consisting of one or more anion and cation exchange beads fused together with a binder polymer to form a resin wafer consisting of hydrophobic and hydrophilic domains and with internal-porosity exposing the hydrophilic domains.

3. The method of claim 2, wherein the ionic species or the ionizable species is a small molecule acid with fewer than 4 carbon atoms.

4. The method of claim 3, wherein the small molecule acid is selected from the group consisting of by formic acid, acetic acid, lactic acid, butanoic acid, derivatives thereof, and salts thereof.

5. The method of claim 3, wherein the ionic species comprise inorganic acids selected from the group consisting of carbonic acid, bicarbonate, carbonate, salts thereof, and mixtures of one or more of the former.

6. The method of claim 1, wherein the reaction crude contains a small ionic species or ionizable species of varying concentration and the desired product stream recovered from the ion-concentration compartment is desired to be in a constant concentration range.

7. The method of claim 6, wherein the ionic concentration of the product is in the range of 10 ppm to 40 mol % in water.

8. The method of claim 7, wherein the desired product is a non-ionic species, and the product requirement is high purity, with the ionic component in the range of 10 ppm-1 mol %.

9. The method of claim 7, wherein the desired product is the ionic species and the product requirement is high purity, with the ionic component in the range of 4-40 mol %.

10. The method of claim 1, wherein the membranes of the ion concentrate compartments adjacent to the anode and cathode, which is typically bipolar membranes are replaced with anionomer and cationomer exchange membranes at the anode and cathode respectively. In another embodiment the cationomer and anionomer exchange membranes are replaced with non-ion specific diaphragms for the removal of inorganic ionic species such as carbonic acid, bicarbonate salts, and/or carbonate salts

11. The method of claim 1, wherein the reaction crude contains monoethylene, diethylene glycol, triethylene glycol, propylene glycol, mixtures thereof, or other water soluble non-charged product molecules produced from the reduction of carbon dioxide or carbon monoxide.

12. The method of claim 1, further comprising using resin-wafer electrodeionization (RW-EDI) to reduce the energy consumption compared to conventional evaporation techniques.

13. The method of claim 1, wherein the reaction crude contains formic acid, alkali, alkali-earth metal salt, or combinations thereof.

14. The method of claim 8, wherein the product is formic acid or formate salt.

15. The method of claim 1, wherein the at least one ion-depletion compartment is interposed adjacently between pairs of ion-concentration compartments.
